(19) United States
(12) Patent Application Publication
(10) Pub. No.: US 2026/0356050 A1
(43) Pub. Date: Nov. 12, 2026

(54) METHOD FOR PRODUCING AN ADHESIVE BOND

(71) Applicant: HELLA GMBH & CO. KGAA, Lippstadt (DE)

(72) Inventor: Christian Wieck, Lippstadt (DE)

(21) Appl. No.: 19/130,625

(22) PCT Filed: Nov. 2, 2023
(86) PCT No.: PCT/EP2023/080527

§ 371 Date: May 16, 2025

(30) Foreign Application Priority Data
Nov. 17, 2022 (DE) 10 2022 130 405.1

(51) Int. Cl. B29C 65/54; B29C 65/00; B29C 65/48; B29L 31/00; F21S 41/29

(52) U.S. Cl. CPC B29C 65/54; B29C 65/4845; B29C 66/90; F21S 41/29; B29L 2031/747

(57) ABSTRACT

The present invention relates to a method for producing an adhesive bond between a first component and a second component. The method includes the following steps in a non-fixed sequence: providing the first component which has a pin; providing the second component which has a cavity, wherein the cavity has an upper opening and a lower opening; positioning the second component on the first component, wherein the pin is introduced into the cavity through the lower opening; filling a first adhesive into the cavity; aligning the components with respect to one another such that the second component assumes a target pose relative to the first component; curing the first adhesive; and obtaining the adhesive bond.

### CROSS-REFERENCE TO RELATED APPLICATIONS

This application is the National Stage of International Application No. PCT/EP2023/080527 filed on Nov. 2, 2023, which claims priority to and all advantages of German Patent Application No. 10 2022 130 405.1 filed on Nov. 17, 2022, the disclosures of which are hereby incorporated by reference in their entirety.

### FIELD OF THE INVENTION

The present invention relates to a method for producing an adhesive bond between a first component and a second component, in particular as components of a motor vehicle lighting device.

### BACKGROUND

Modern motor vehicle lighting devices, in particular headlights, place high demands on the precise positioning and orientation of light-technical components such as lenses or reflectors relative to the associated illuminant units. These high tolerance requirements must be taken into account during production, and the alignment of the light-technical components must also remain within the tolerance range during practical and continuous operation of the lighting device. The light-technical components and/or associated holders are usually fixed in their target pose on a carrier by means of adhesive bonds, wherein in particular such adhesive bonds are produced in which a component-side pin protrudes as a connecting pin into a cavity filled with adhesive on the carrier. This type of adhesive bond offers the possibility of fine-tuning the alignment of the light-technical components, typically while the illuminant unit is in operation and observing the resulting light impression on a projection surface.

A disadvantage of using adhesive bonds is the volumetric shrinkage of adhesives during curing, which can result in a change in the adjusted position of the light-technical components and a corresponding unwanted change in the light impression created by the lighting device. In the prior art, approaches for avoiding impairments associated with adhesive shrinkage are known; for example WO 2021/115581 A1 and WO 2021/115582 A1 disclose methods for establishing adhesive bonds between a pin and a cavity using rigid or flexible spacers in the bottom of the cavity and pre-fixing the adhesive bond with a fast-curing UV adhesive.

### SUMMARY

The object of the present invention is to propose a further development of a method for producing an adhesive bond, wherein the adhesive bond is formed between a pin of a first component and a cavity of a second component.

This object is achieved on the basis of a method according to embodiments of the present invention. Advantageous further developments of the invention are given in further embodiments.

The invention includes the technical teaching that the method for producing the adhesive bond comprises the following steps in a non-fixed order:
providing the first component which has a pin,
providing the second component which has a cavity, wherein the cavity has an upper opening and a lower opening,
positioning the second component on the first component, wherein the pin is introduced into the cavity through the lower opening,
filling a first adhesive into the cavity,
aligning the components with respect to one another such that the second component assumes a target pose relative to the first component,
curing the first adhesive, and
obtaining the adhesive bond.

The invention is based on the idea of reversing the joining arrangement known from the prior art with a pin projecting into the cavity from above by providing the cavity with a second, lower opening for introducing the pin. The second component is thus positioned above the first component, wherein the pin protrudes into the cavity from below. In particular, this has the advantage that the amount of adhesive required to form the bond can be less than with an adhesive bond from the prior art. With the latter, there is always a dead volume between the base of the cavity and the pin protruding into the cavity from above, which must be filled with adhesive. Due to the lower amount of adhesive and the special bond geometry, the volumetric shrinkage during curing of the adhesive is also lower in an adhesive bond produced according to the method of the invention, resulting in improved positional accuracy, i.e. the deviations of the previously adjusted target pose of the second component relative to the first component caused by the shrinkage are lower than in prior art methods. When using the method according to the invention for producing adhesive bonds between components whose pins or cavities have characteristic dimensions in the order of 10 millimeters, the change in position of the cavities relative to the pins caused by adhesive shrinkage is typically less than 10 micrometers.

Another advantage of the method according to the invention is the improved accessibility of the cavity even after the second component has been positioned on the first component, as the upper opening of the cavity is not covered by the first component, unlike in the joining arrangements from the prior art. The first adhesive, and optionally further adhesives, can therefore be easily filled into the cavity through the upper opening after the second component has been positioned on the first component. Alternatively, the first adhesive can be filled in before the second component is positioned on the first component, i.e. before the pin is introduced into the cavity.

In the present case, the term “cavity” refers to an appropriate receiving space that is suitable for receiving an adhesive and at least one section of a pin. Such a receiving space can be formed, for example, by a pit-shaped depression or a cup-shaped formation on the second component. In the present case, the term “pin” refers to an element that protrudes from the first component, in particular in the form of a pin, which is suitable for introduction into the cavity of the second component.

The method according to the invention is in principle not limited to a specific type of adhesive, and in particular the term “curing” is used in the present case to comprise, without limiting the generality, any process leading to the solidification of an adhesive, in particular all processes of chemical curing (polymerization, polyaddition, etc.) or physical setting (drying, cooling, etc.).

In an advantageous embodiment, the first adhesive is provided as a highly viscous or viscoelastic adhesive. The flowability of the adhesive is so low that the adhesive does not flow out through the lower opening of the cavity during a process-specific period between filling into the cavity and curing.

In another embodiment, after the first adhesive has cured, a second adhesive is filled into the cavity and cured. In particular, the first adhesive can only serve to pre-fix the adjusted target pose of the second component, and the final strength of the adhesive bond is only generated by the second adhesive. For example, the second adhesive is designed as a 2-component polyurethane-based adhesive.

Advantageously, the first adhesive is cured by irradiation with ultraviolet light (UV). UV curing enables fast process control, and UV irradiation can be realized without any problems due to the free accessibility of the cavity via the upper opening.

For example, the first component and the second component are provided as components of a motor vehicle lighting device, in particular a headlight, wherein the first component is provided as a carrier and the second component is provided as a light-technical component, in particular a reflector or a lens, for an illuminant unit. In particular, when aligning the components relative to one another, the illuminant unit is operated and a resulting light impression is monitored such that the second component assuming the target pose relative to the first component is indicated by achieving a target light impression.

### BRIEF DESCRIPTION OF THE DRAWINGS

Further measures improving the invention are depicted below together with the description of a preferred exemplary embodiment of the invention with reference to the figures. The figures show, in a schematic cross-sectional view:

FIG. 1: a joining arrangement with adhesive bond produced according to the invention, and

FIGS. 2a-2d: a sequence of steps in the production of an adhesive bond according to the invention.

### DETAILED DESCRIPTION

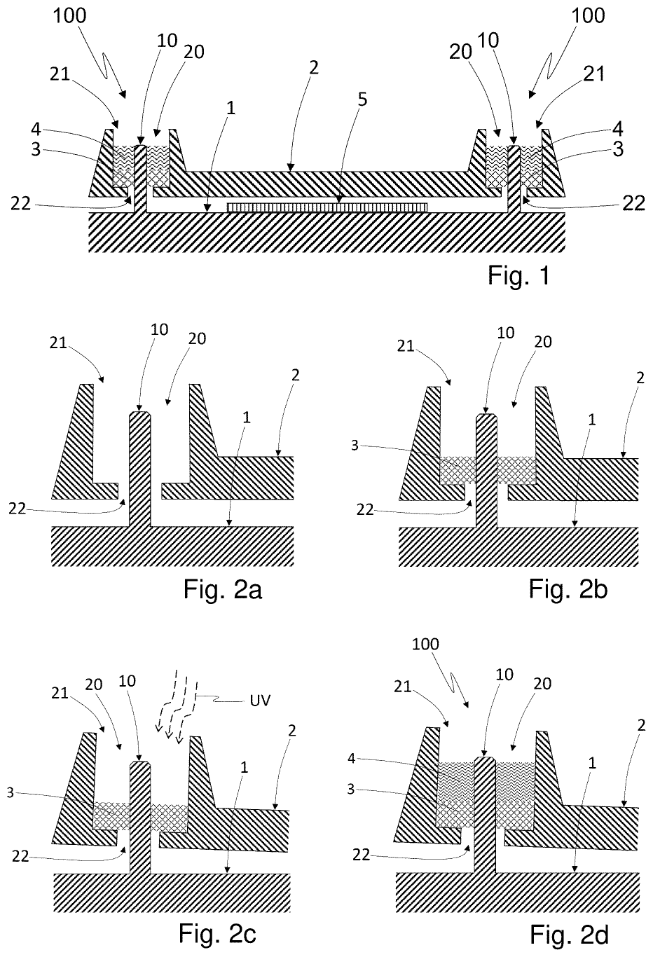

FIG. 1 shows a schematic cross-sectional view of a joining arrangement consisting of a first component 1 and a second component 2, which are connected to one another by means of (at least) two adhesive bonds 100 produced according to the invention. As components of a light module of a motor vehicle lighting device, the first component 1 is designed as a carrier and the second component 2 is designed as a lens system. The lighting unit 5, which comprises a matrix-shaped arrangement of LEDs, is arranged on the first component 1. For the desired performance of the light module, high-precision alignment of the lenses relative to the LEDs (in each case outside the sectional plane shown) is required, and therefore the pose, i.e. the position and orientation of the second component 2 relative to the first component 1, must correspond to an associated target pose with as little deviation as possible.

To create the two adhesive bonds 100, the first component 1 has the two pins 10 and the second component 2 has the two cavities 20. The cavities 20 are designed as receiving spaces for the cup-shaped moldings on the second component 2 and each have the upper opening 21 and the lower opening 22. The pins 1 each protrude through the lower opening 22 into the cavities 20, and the adhesive bonds 100 are formed by the first adhesive 3 and the second adhesive 4. The change in position of the cavities 20 relative to the pins 10 caused by adhesive shrinkage during curing is typically less than 10 micrometers when using the method according to the invention.

To illustrate the method according to the invention, FIG. 2a-2d show a sequence of steps in the production of an adhesive bond 100 according to the exemplary joining arrangement of FIG. 1.

FIG. 2a shows the state after the second component 2 has been positioned on the first component 1, wherein the pin 10 has been introduced into the cavity 20 through the lower opening 22. The second component 2 is typically held on a manipulator that is not shown and is in an initial pose, from which the target pose is adjusted in the further process.

FIG. 2b shows the state after the first adhesive 3 has been filled into the cavity 20. As shown, the lower opening 22 is located geodetically below the upper opening 21 when the adhesive bond is produced, so that gravity drives the first adhesive 3 towards the lower opening 22. Therefore, the first adhesive 3 is preferably provided as a highly viscous or viscoelastic adhesive so that it does not flow out of the cavity 20 through the lower opening 22, or at least not in a significant amount, until it has cured.

FIG. 2c shows the curing of the first adhesive 3 after aligning the components 1, 2 to one another. In the state shown, the second component 2 is in the target pose relative to the first component 1. When aligning components 1 and 2, illuminant unit 5 (see FIG. 1) was operated to find the target pose and the resulting light impression was monitored, for example on a projection screen at a distance. The assumption of the target pose of the second component 2 relative to the first component 1 is indicated by achieving a target light impression. The curing of the first adhesive 3 is carried out by irradiation with ultraviolet light UV via the upper opening 21.

FIG. 2d shows the final adhesive bond 100, wherein after the first adhesive 3 has cured, the second adhesive 4 was filled into the cavity 20 via the freely accessible upper opening 21 and cured. The second adhesive 4 is designed, for example, as a chemically curing 2-component adhesive and ensures the necessary final strength of the adhesive bond 100. The adhesive bond 100 produced according to the invention requires smaller amounts of adhesive 3, 4 compared to known pin-cavity adhesive bonds from the prior art, since in the present case no dead volume in the base of the cavity has to be filled with adhesive, but rather the layers of the first adhesive 3 located directly above the lower opening 22 are already in contact with the protruding pin 10. As a result, the volumetric adhesive shrinkage during curing is also lower than with adhesive bonds from the prior art, which results in the particular accuracy of the adhesive bond 100 produced according to the invention in relation to the adjusted target pose of the second component 2 relative to the first component 1.

The invention is not limited in its implementation to the preferred exemplary embodiment given above. Rather, a number of variants are conceivable which make use of the solution presented, even for fundamentally different designs. All features and/or advantages arising from the claims, the description or the drawings, including design details, spatial arrangements and method steps, may be essential to the invention both individually and in a wide variety of combinations.

### LIST OF REFERENCE SIGNS

100 adhesive bond
1 first component
10 pin
2 second component
20 cavity
21 upper opening
22 lower opening
3 first adhesive
4 second adhesive
5 illuminant unit
UV ultraviolet light

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for producing an adhesive bond between a first component and a second component, comprising the following steps in a non-fixed sequence:
providing the first component which has a pin,
providing the second component which has a cavity, wherein the cavity has an upper opening and a lower opening,
positioning the second component on the first component, wherein the pin is introduced into the cavity through the lower opening,
filling a first adhesive into the cavity,
aligning the components with respect to one another such that the second component assumes a target pose relative to the first component,
curing the first adhesive, and
obtaining the adhesive bond.

2. The method according to claim 1, wherein the first adhesive is provided as a highly viscous or viscoelastic adhesive.

3. The method according to claim 1, wherein after the first adhesive has cured, a second adhesive is filled into the cavity and cured.

4. The method according to claim 1, wherein the first adhesive is cured by irradiation with ultraviolet light (UV).

5. The method according to claim 1, wherein the first component and the second component are provided as components of a motor vehicle lighting device, wherein the first component is provided as a carrier and the second component is provided as a light-technical component, in particular a reflector or a lens, for an illuminant unit.

6. The method according to claim 5, wherein, when aligning the components relative to one another, the illuminant unit is operated and a resulting light impression is monitored such that the second component assuming the target pose relative to the first component is indicated by achieving a target light impression.
